(19) United States
(12) Patent Application Publication
(10) Pub. No.: US 2002/0041920 A1
(43) Pub. Date: Apr. 11, 2002

(54) Egg, omelets and the like cooking method and apparatus

(76) Inventor: Juan Fernandez, Ridgefield Park, NJ (US)

Correspondence Address: KILPATRICK STOCKTON LLP, 607 14TH STREET, N.W., SUITE 900, WASHINGTON, DC, 20005, US

(21) Appl. No.: 09/766,831

(22) Filed: Jan. 23, 2001

Related U.S. Application Data
(60) Provisional application No. 60/239,090, filed on Oct. 11, 2000.

(51) Int. Cl. A23L 3/00; A23L 1/00

(52) U.S. Cl. 426/243; 426/614; 99/348

(57) ABSTRACT

A novel apparatus and method for cooking eggs or similar meals on a stove or in a microwave oven is provided. The cooking device enables users to cook a variety of egg type meals. The device provides the user with a manner to quickly and easily create omelets or scrambled type meals by mixing the eggs, or the like. The device provides an easy and neat manner to create “sunny side up” eggs, or the like.

### CROSS-REFERENCE TO RELATED APPLICATIONS

The present invention is related to, and incorporates the entire disclosure by reference of, U.S. patent application Ser. No. 09/606,197, entitled “Cooking Method And Apparatus,” filed Jun. 29, 2000.

This application claims priority to Provisional Patent Application, Serial No. 60/239,090, entitled “Egg, Omelets and the like Cooking Method and Apparatus,” filed Oct. 11, 2000.

### BACKGROUND OF THE INVENTION

The subject matter of the present invention generally relates to the activity of cooking and specifically to devices and methods for cooking eggs on a stove or in a microwave oven. Cooking of eggs is a popular and fast meal staple or addition. Microwave cooking has become popular in large part because of its ability to limit the time, complexity, and amount of added fat usually associated with conventional cooking.

Traditionally, microwave cooking of eggs is rare because of the difficulties associated with preparing and containing the egg(s) for various styles. Cooking an omelet, scrambled eggs, “sunny-side up eggs,” and other egg meals in a microwave has previously been unworkable or limited. Independent of how cooked, conventional methods typically proved costly due to expenses such as the pan, oil, butter or the repeated costs of purchasing frozen meals.

The preferred embodiments of the present invention provide a cooking device that can be used to avoid the foregoing difficulties by the incorporation of a scramble slice and a plate with a shaped depression and an air vent. The scramble slice enables easy creation of omelets and the scrambling of eggs in the device, without supplemental utensils. The plate with shaped depression and air vent allow for controlled cooking of an egg by containing the egg within the depression and by providing ventilation to avoid egg white overflow during cooking. The present invention can be cost and health effective because oil and butter, or the like, are no longer needed.

### DESCRIPTION

### Brief Summary of the Invention

The present invention provides a novel cooking method and apparatus that is preferably used to quickly, easily, and healthily cook eggs, omelets, other egg-based products, and the like. Embodiments of the device can be used with a traditional stove or, preferably, with a microwave oven.

The preferred embodiments generally include an omelet bowl, a scramble slice, and a plate with a depression and an air vent. The omelet bowl is used to hold the eggs for making omelets and scrambled eggs, for example. The scramble slice is inserted into the omelet bowl to enable the user to scramble or mix the eggs while they are in the omelet bowl. The plate with a depression and an air vent also has an air vent cap. Note that the air vent is not located inside the depression, but is rather outside, or exterior, of the depression. The plate can be flipped over and used as the top of the omelet bowl top for making omelets, scrambles, and the like. The plate is used alone, inner side up, for preparing “sunny side up” style eggs. Of course, other styles of egg cooking, besides “sunny side up,” are possible in the plate, depending on cook time and pre-cooking preparation of the eggs.

In operation, the user first decides whether they wish to create an omelet or scrambled type egg, or a “sunny side up” type egg or the like. For an omelet, the user simply inserts the scramble slice into the omelet bowl and then places or cracks the egg(s) into the bowl. At this time the user can add ingredients, especially when an omelet is planned, and season to taste. Next, the plate is used to cover the omelet bowl by simply turning it over and snapping it onto the bowl. With the top securely snapped on and the air vent cap covering the air vent, the user simply shakes the apparatus so as to mix the egg(s) and other ingredients by forcing them back and forth through the grating of the scramble slice. While egg(s) generally reach a steady level of mixture, they, and especially other food types, can be mixed more or less at the discretion of the user.

Operating the cooking device to create scrambled eggs is similar to the stated procedure for creating an omelet. In some embodiments, however, the device may be shaken at least one intermediate time during cooking. The user may choose to shake the contents before the cooking begins at their discretion. Various scrambled meals are created depending on the ingredients added, the temperature and time of cooking, and the timing, quality, and quantity of the shaking.

For operating the cooking device to cook “sunny side up” eggs or variations thereof, the user simply places or cracks the egg(s) into the depression of the plate. The depression, which may be of any shape desired by the manufacturer, works to contain the egg(s) within the depressed area, and away from the edges of the plate's inner surface. Before or after inserting the egg, the user can add ingredients or adjust the egg(s) as desired. Once ready to cook, the user should ensure that the air vent cap is not obstructing the air vent and then cook on the stove or in the microwave, depending on the embodiment of the device being used. The cooking time and temperature are variable and the user can cook to their tastes.

The present invention provides a novel apparatus and method to create meals in a microwave oven. Benefits include quickness, facility, healthiness, and cost effectiveness. Meals can be made, for example, in the time that it usually takes to make toast. The preferred embodiments are simple enough to be operated by a child. Meals become much more healthy without the need for higher fat and cholesterol levels typically used in frying and present in most frozen meals. Meal variations are endless and range from exotic omelets to egg tortillas to pizza fritta. Cost benefits of the invention stem from the ability to avoid the expense of cooking agents, such as oil and butter. Cost benefits also stem from the avoidance of repeated purchases of purchasing frozen meals. Whether the device is of the material for cooking on a stove or in a microwave, non-stick surfaces are preferred.

Further objects and advantages of my invention will become apparent from a consideration of the drawings and the ensuing description.

### BRIEF DESCRIPTION OF THE DRAWINGS

The present invention is shown by way of example and not limitation in the attached FIGS., in which:

FIG. 1 is an overall plan view showing one embodiment of the invention;

FIG. 2 is a side section view of the bowl;

FIG. 3 is a side view, half in section, of the embodiment shown in FIG. 1;

FIG. 4 is a bottom view of the bowl;

FIG. 5 is a side view of the scramble slice;

FIG. 6 is a section view of the grate of the scramble slice of FIG. 5;

FIG. 7 is a bottom view of the scramble slice;

FIG. 8 is a side section view of the egg shaped plate;

FIG. 9 is a direct view of the egg shaped plate inner;

FIG. 10 is a direct view of the egg shaped plate outer;

FIG. 11 is a side view of the air vent cap;

FIG. 12 is a bottom view of the air cap;

FIG. 13 is a zoom view of the hinged connector of FIG. 12;

FIG. 14 is a plan view of the egg shaped plate;

FIG. 15 is a plan view of the egg shaped plate with an egg in it.

### DETAILED DESCRIPTION OF THE PREFERRED EMBODIMENTS OF THE INVENTION

The preferred embodiments provide a cooking device (10) that enables users to create a variety of egg types on a stove or in the microwave. Some potential benefits of the device (10) are the saving of cooking time, fat, cholesterol, and money.

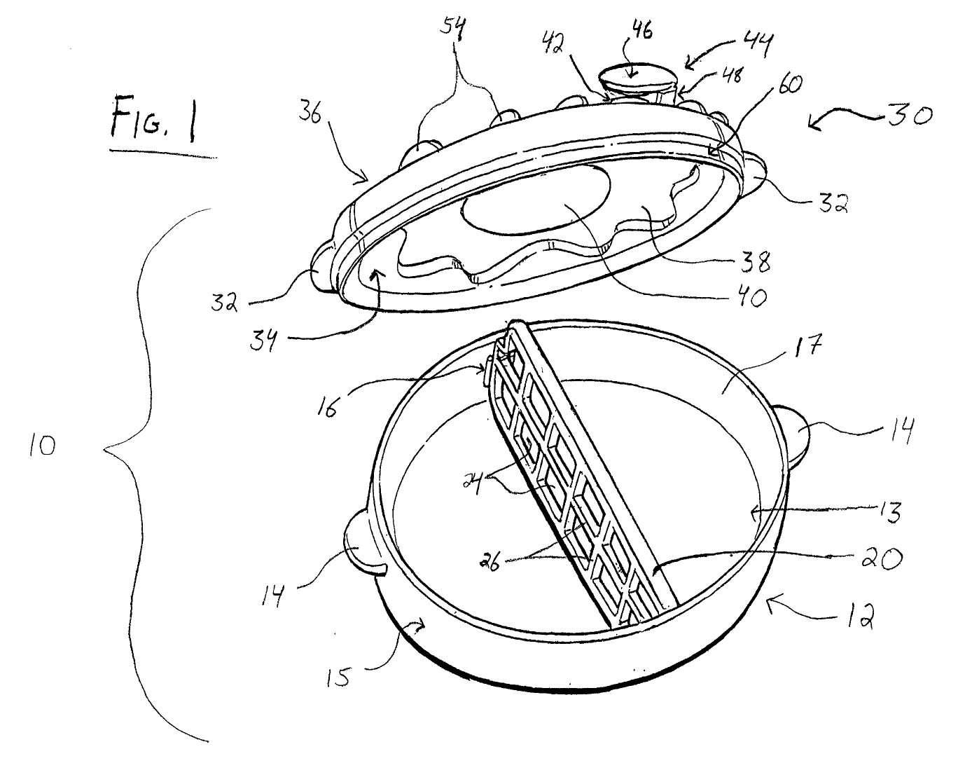

FIG. 1 shows the cooking device (10) and its four major components: the omelet bowl (12); the scramble slice (20); the egg shaped plate (30); and the air vent cap (44). The omelet bowl (12) can be used with or without the scramble slice (20), which is removably placed inside (13) of the omelet bowl, for cooking meals such as omelets and scrambled eggs. The egg shaped plate (30) is the cover for the omelet bowl (12) and preferably, doubles, when inverted, as a cooking plate for “sunny side up” eggs and the like.

The omelet bowl (12) includes handles (14) on the bowl exterior sides (15) and fixtures (16) on the bowl interior sides (17), as can be seen in FIG. 1. A grated vertical divider, or scramble slice (20) can be secured in the bowl (12) by fixtures (16). Preferably, there is a substantially flush fit between the edges of the scramble slice edges (22) and the interior (13) of the omelet bowl. This aids in mixing and avoids the trapping of matter by forcing the food stuff through the spaces (24). The size and orientation of the scramble slice (20) is not limited to that shown in the figures. For example, the scramble slide (20) could be a horizontal divider with a peripheral shape that substantially matches the interior sides (17) of the bowl. In this example, the fixtures (16) on the bowl sides (17) could be in the form of, for example, a single circumferential flange, separate horizontal flanges, or the like.

The bowl (12) also has bottom grips (18) on its bottom side (19) for keeping the bowl from sliding on surfaces, including on the inside of the microwave. The bottom grips (19) can also act as thermal insulation between the invention and said surfaces.

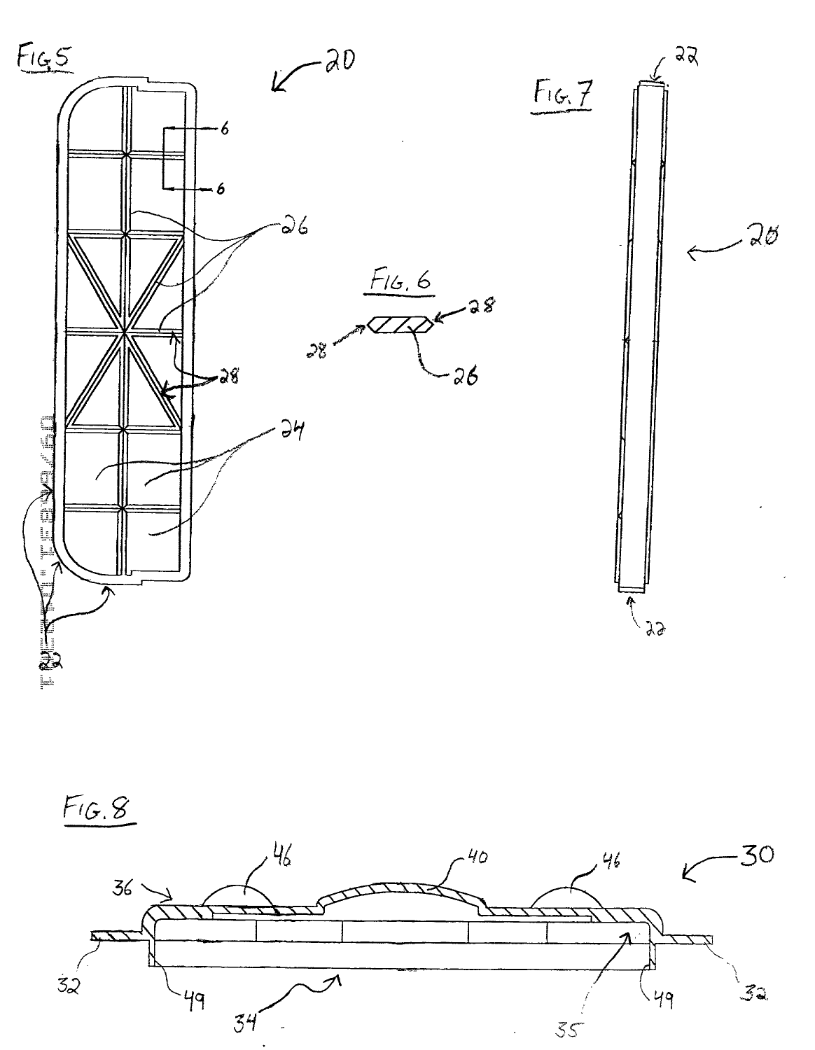

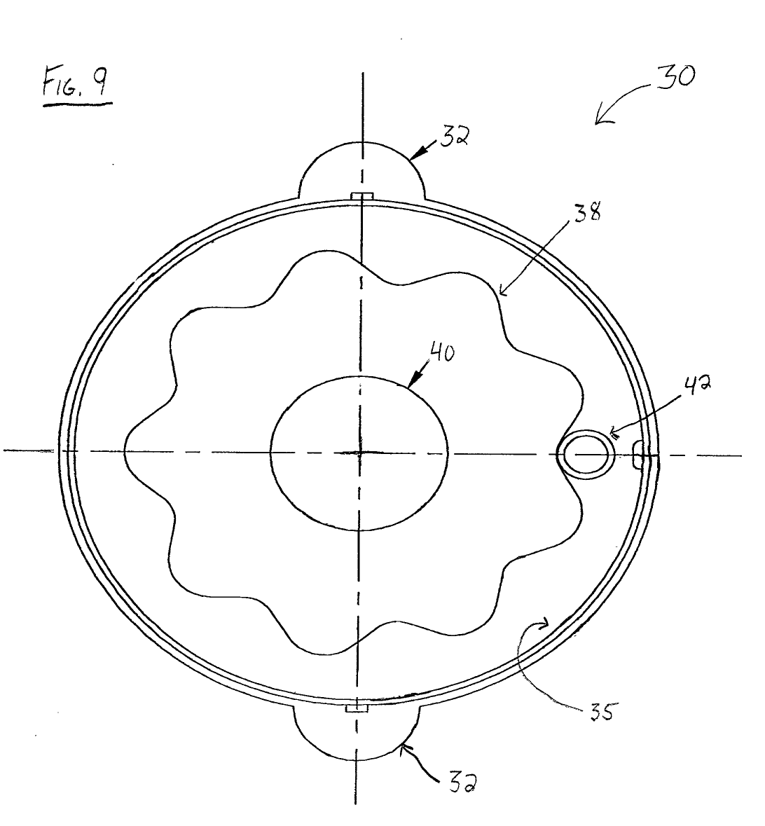

The Scramble Slice (20), as shown in FIGS. 1 and 5-7, is an accessory that can be securely and removably placed into the omelet bowl. The Scramble Slice acts as a mixer by separating the food stuffs that are passed, back and forth, between the spaces (24) in its grating (26). The mixing interfaces (28) of the grating (26) can be of any desired quality. The preferred quality has a pointed shape, as shown in FIG. 6, which contributes to the mixing process by separating more than the blunted shape shown in FIG. 1.

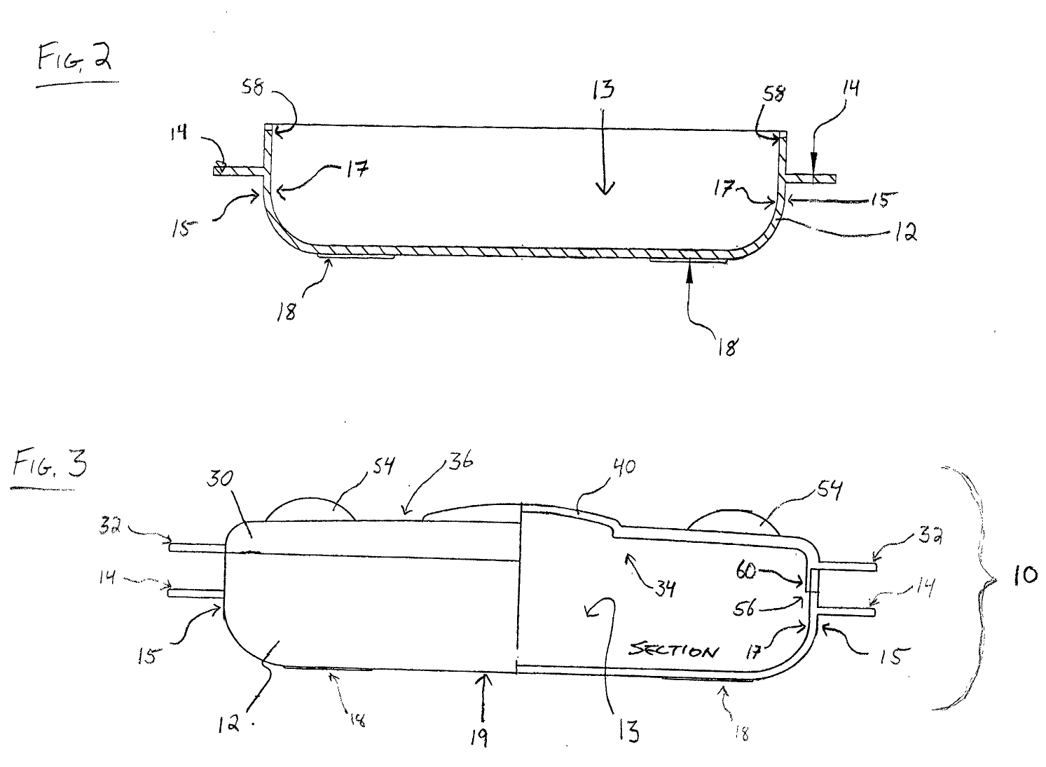

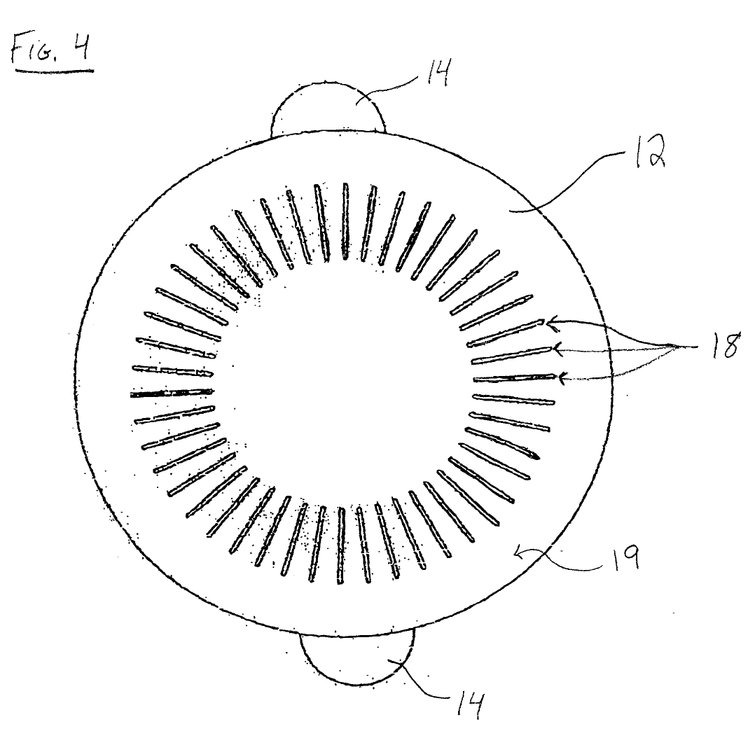

The egg shaped plate (30) acts as the cover for the cooking device (10), as shown in FIG. 3. The egg shaped plate (30) can be securely connected to the omelet bowl (12) at a snap fit interface (56), as shown in FIG. 3. This snap fit is created by the relative shapes of the edge (58) of the bowl (12), shown in FIG. 2, and the edge (60) of the plate (30), shown in FIGS. 1 and 3, in a manner traditionally known for releasably and frictionally connecting such separate components. The egg shaped plate (30) also has handles (32). For shaking the contents to be cooked, as described below, a user can easily grasp all of the handles shown in FIG. 3. Although the configuration of handles is shown to be on opposing sides of the omelet bowl (12) and of the egg shaped plate (30), various quality and quantity of handles can be implemented as the manufacturer prefers.

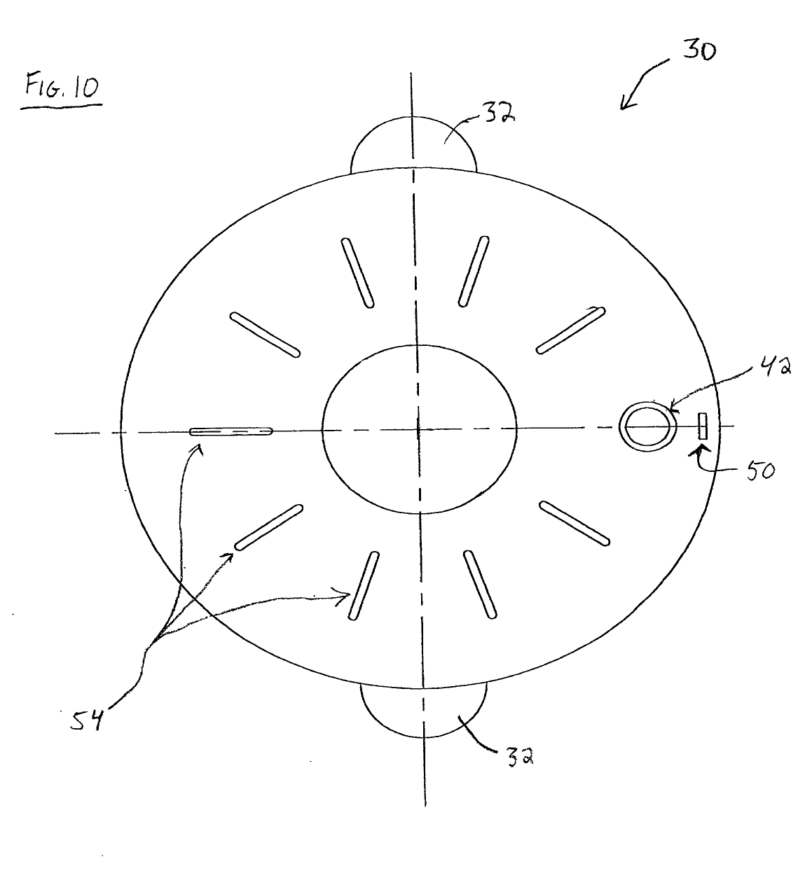

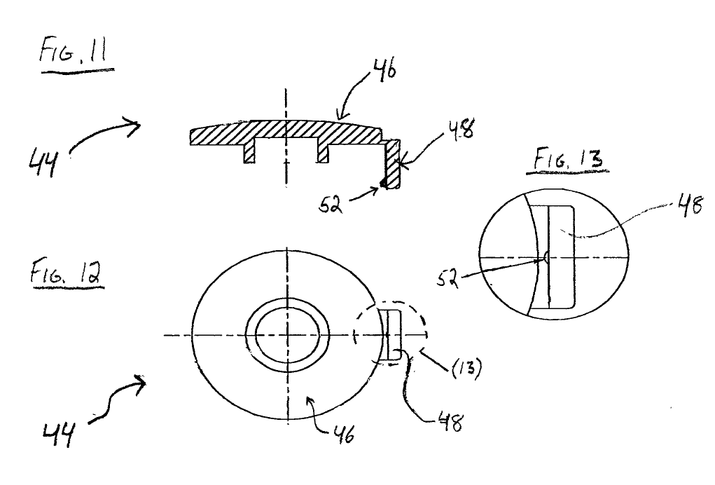

The air vent is not necessarily always needed. For example, during preferred omelet or scramble egg creation, outlined below, the air vent is preferably plugged. An air vent cap (44) is removably connected to the egg shaped plate (30) by inserting the connector (48) of the cap (44) into the anchoring hole (50), shown in FIG. 10, of the egg shaped plate (30). The connector (48) is hingedly connected to the main body (46) of the cap (44) and possesses a dimple (52) on its lower end. The dimple (52) acts to frictionally, yet still releasably, secure the connector (48) in the anchor hole (50).

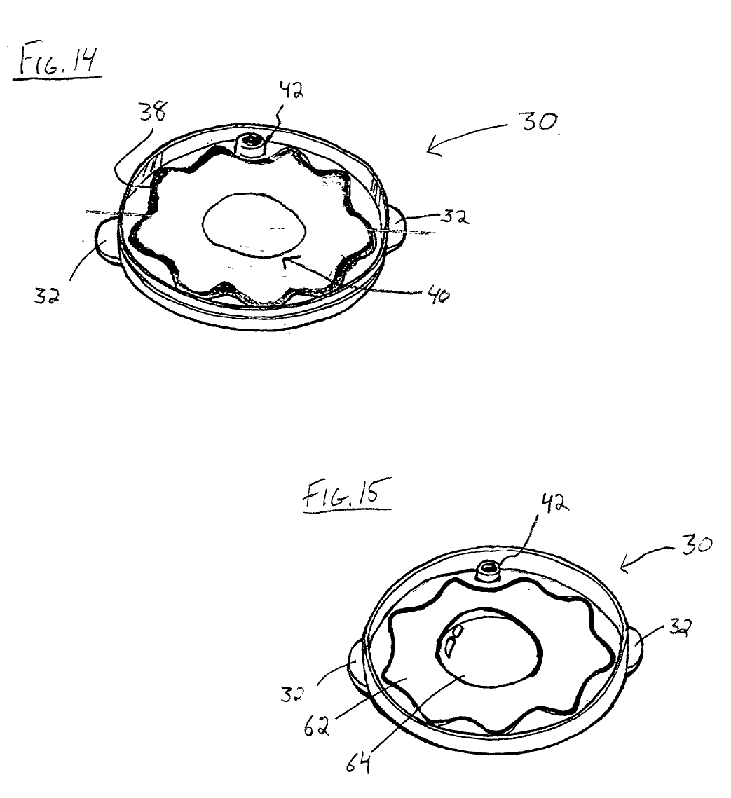

For cooking flat, “sunny side up,” or similar meals, the egg shaped plate (30) assumes the other of its dual roles. As mentioned, the egg shaped plate (30) can act as the cover for the omelet bowl (12) and novelly doubles as a specially adapted surface for cooking eggs when it is inverted. The egg shaped plate (30) is especially beneficially because its inner surface (34) can have an egg shaped depression (38) and a yoke indentation (40) to contain the egg. Another novel and beneficial quality of the egg shaped plate is an air vent (42). This air vent (42) functions to avoid egg white overflow and keeps the foodstuffs from reaching the edge (35) of the interior (34) of the plate. During covered or uncovered microwave cooking, whites of eggs tend to naturally spread. This spreading often creates quite a mess. The depression (38), indentation (40), and ventilation provided by the vent (42) combine to neatly contain the egg. When the egg shaped plate (30) is used as a plate, as shown in FIGS. 14 and 15, opposed to a cover, as shown in FIGS. 1 and 3, the extension of the air vent (42) on the exterior side (36) of the egg shaped plate (30), as shown in FIG. 1, is kept from the surface which the plate is to be placed on by the elevation pegs (54). These pegs (54), like aforementioned bottom grips, can also possess gripping and thermal insulation functions.

Materials employed in the device (10) can vary depending on the intended application. The materials for the omelet bowl (12) range from electric and gas stove top compatible materials such as steel, glass, ceramic, and non-stick surfaces to—in the most preferred embodiments—microwave oven friendly materials such as plastics or glass. Other material determining variables are such as weight, appearance, cost, availability, robustness, and the ability to be shaped during manufacture.

In operation for cooking omelets, scrambled eggs, or the like, the user first inserts the scramble slice (20) into the omelet bowl (12). The user then places or cracks the eggs, or desired food stuffs, into the bowl (12). The user then puts in any additional ingredients, such as vegetables, meats, cheese, and seasonings, as desired. After securely fastening the plate (30) to the bowl (12) the user then can grasp the handles and shake the device so as to easily mix the ingredients. The amount of shaking is discretionary. The shaking is preferably done in a manner that increases the flow of material back and forth through the scramble slice (20). For example, a vertically disposed slice (20), as shown in FIG. 1, would be maximized when the device (10) is shaken in a substantially horizontal plane. This may differ if a horizontally disposed scramble slice (20), as mentioned but not shown, was used. After shaking, the device is placed in the microwave oven for the desired (and typically short) cooking time. For scrambled styles, or the like, the user may wish to remove the container from the microwave, or the like, prior to completion of the cooking, shake the device, and then return container to the microwave, or the like, to continue cooking. This may be done more than once during cooking, as desired.

In operation for cooking “sunny side up” style eggs or the like, the egg shaped plate (30), as shown in FIG. 14, can be inverted from its cover disposition and used for containing the egg(s). The egg(s) (62) are simply placed or cracked into the egg shaped depression (38), as shown in FIG. 15. After adding any desired additional ingredients and seasonings, the user proceeds to cook the egg on a stove or, in the preferred embodiment, in a microwave oven.

The user will select the desired cooking variables, such as time and temperature and shaking strategy, based on the circumstances.

While the present disclosure describes some exemplary embodiments, the described and illustrated embodiments are shown by way of example and not limitation. Those in the art should appreciate that various modifications, embodiments and the like can be made based on the instant disclosure.

1. A device for cooking, comprising:
a bowl with interior sides;
fixtures attached to said interior sides;
a mixing element that can be removably placed in said bowl and secured in place for use by said fixtures; and
a cover for the bowl, said cover having an upper and a lower surface.

2. The device of claim 1, wherein said cover has at least one depression in said lower surface, which at least one depression can contain food from reaching the air vent and inside edges of the cover.

3. The device of claim 2, wherein said cover further includes an air vent that is external of said at least one depression.

4. The device of claim 3, wherein said cover further includes pegs extending upward from said upper surface.

5. The device of claim 1, wherein said device is made of microwavable materials.

6. A cooking device for use on a traditional stove or in a microwave, said device comprising:
a bowl, with handles attached to the exterior sides, fixtures attached to interior sides, and bottom grips that provide frictional support for slip avoidance and thermal insulation for the bowl;
a partitioned mixing element that has edges that are shaped to be generally flush with the interior sides of the bowl, is removably placed in said bowl, has pointed mixing surfaces, and is secured in place by said fixtures; and
a cover for the bowl, said cover having an upper surface, a lower surface, elevating pegs on the upper surface, and an air vent for relieving pressure buildup during cooking.

7. The cooking device of claim 6, wherein said air vent can be covered by an air vent cap that is removably and hingedly secured to said upper surface.

8. The cooking device of claim 6, wherein said device is made of microwavable materials.

9. A method for cooking, comprising:
a) removably placing a partitioned mixing device into a bowl; and
b) adding foodstuffs to either the bowl or to a depression that is located in an inside surface of a bowl cover.

10. The method of cooking of claim 9, wherein the foodstuffs are placed in the bowl and further including:
c) securing a cover to the bowl;
d) shaking the entire device so as to mix the contents;
e) placing the food filled bowl and cover into a microwave oven; and
f) cooking the food in the microwave oven.

11. The method of cooking of claim 9, wherein the foodstuffs are placed in the bowl and further including:
c) securing a cover to the bowl;
d) shaking the entire device so as to mix the contents;
e) placing the food filled bowl and cover onto a conventional stove; and
f) cooking the food on the stove.

12. The method of cooking of claim 9, wherein the foodstuffs are added to the at least one depression in the inside surface of the cover and further including:
c) placing the foodstuff filled cover onto a conventional stove; and
d) cooking the food on the stove while the foodstuff is still in the cover.

13. The method of cooking of claim 9, wherein the foodstuffs are added to the at least one depression in the inside surface of the cover and further including:
c) placing the foodstuff filled cover into a microwave oven; and
d) cooking the food in the oven while the foodstuff is still in the cover.

14. The method of cooking of claim 9, further comprising the step of providing an air vent in said cover and an air vent cap for discretionary capping of the air vent.

15. A method for cooking, comprising:
a) providing a bowl with handles on outside side walls of the bowl and fixtures on the inside side walls of the bowl;
b) providing a cover with handles on the outside side walls of the cover and having at least one depression in an inner surface for holding foodstuffs;
c) removably placing a partitioned mixing device into said bowl by connecting the mixing device to said fixtures, said mixing device having edges that are substantially flush with an inside surface of the bowl; and
d) adding foodstuffs to either the bowl or the at least one depression.

16. The method for cooking of claim 15, wherein the foodstuffs are added to the bowl and then:
e) securing the cover to the bowl in a substantially air-tight manner;
f) shaking the bowl and cover, with the foodstuffs inside, so as to mix the foodstuffs;
g) adding the foodstuff filled bowl and cover into a conventional microwave; and
h) cooking the food in the microwave while the food is still in the device.

17. The method for cooking of claim 15, wherein the foodstuffs are added to the bowl and then:
e) securing the cover to the bowl in a substantially air-tight manner;
f) shaking the bowl and cover, with the foodstuffs inside, so as to mix the foodstuffs;
g) placing the foodstuff filled bowl and cover onto a conventional stove; and
h) cooking the food on the stove while the food is still in the device.

18. The method of cooking of claim 15, wherein the foodstuffs are added to the inner surface of the cover and further comprising:
e) providing the cover with at least two depressions for containing foodstuffs such that the foodstuffs are kept from touching the edges of the inside surface of the cover;
f) providing the cover with an air vent that is located outside of the depressions and is bored through the inner and outer surfaces of the cover;
g) placing the cover with the foodstuffs inside in a microwave oven so that elevation pegs, secured to an outer surface of the cover, elevate said outer surface from a surface of the microwave oven; and
h) cooking the food in the microwave oven.

19. The method of cooking of claim 15, wherein the foodstuffs are added to the inner surface of the cover and further comprising:
e) providing the cover with at least two depressions for containing foodstuffs such that the foodstuffs are kept from touching the edges of the inside surface of the cover;
f) providing the cover with an air vent that is located outside of the depressions and is bored through the inner and outer surfaces of the cover;
g) placing the cover with the foodstuffs inside onto a traditional stove; and
h) cooking the food on the stove.

20. The method of cooking of claim 15, wherein the foodstuffs include eggs.
